(19) United States
(12) Patent Application Publication
(10) Pub. No.: US 2011/0278254 A1
(43) Pub. Date: Nov. 17, 2011

(54) HEXAGONAL SEPTA, SEALING ARRANGEMENTS, AND METHODS FOR SEALING CONTAINERS

(75) Inventor: Paul M. PETROSINO, Schoharie, NY (US)

(73) Assignee: INTEGRATED LINER TECHNOLOGIES, INC., Albany, NY (US)

(21) Appl. No.: 12/779,529

(22) Filed: May 13, 2010

(51) Int. Cl. B65D 43/04; B23P 17/04

(52) U.S. Cl. 215/247; 29/505

(57) ABSTRACT

Septa or seals, sealing arrangements and methods of sealing containers are disclosed. The septa may be used for sealing containers containing medications or pharmaceuticals. The septa include a sheet of elastomeric material having a perimeter comprising at least one linear edge. Typically, the septa have a plurality of linear edges, for example, six, that provide a polygonal shaped seal, for example, a hexagonally shaped seal. The septa may be used in conjunction with plates having at least one linear edge, for example, hexagonally shaped plates. When mounted to a container with an appropriate cap, the linear edges of the septa and plates interact to minimize movement of the septa and enhance the sealing of the container.

### CROSS-REFERENCE TO RELATED APPLICATION

This application is related to commonly assigned U.S. design application ______, filed on May 13, 2010 [Attorney ref. 0825.025].

### BACKGROUND OF THE INVENTION

1. Field of the Invention

The present invention relates to container seals, for example, for containers holding medications or pharmaceuticals. More particularly, the present invention relates to container seals or septa with linear edges and sealing arrangements having seals with linear edges, for example, hexagonal shaped septa, that when used with conventional container caps enhance sealing performance.

2. Description of Related Art

Pharmaceutical manufactures, physicians, and other health care professionals rely on a sterile, contaminant-free supply of drugs and other pharmaceuticals. Typically, the safety of such pharmaceuticals is ensured by means of secure and sterile bottling having reliable and sterile container caps. The common crimp cap and plug seal stopper are familiar to most health care professionals and to the public.

Experience has shown and studies have confirmed that the conventional septum seals, for example, retained by crimped or screw caps, can lose some of their sealing capacity during handling. Specifically, mounting of container caps, for example, the crimping of aluminum caps or the screwing on of threaded caps, can dislodge or deform septum seals whereby the desired fluid-tight seal of the container can be compromised. In recognition of the limitations of the present art, the present invention, in its several aspects, was developed.

### SUMMARY OF ASPECTS OF THE INVENTION

Aspects of the present invention overcome the disadvantages of prior art circular septa by providing a septum with one or more linear edges, for example, a hexagonal shaped seal or septum. Septa according to aspects of the invention may be sized to cover the sealing surface of a bottle or vial while concentrating the contact pressure to locations where the linear edges of the septum overlaps a linear edge of a more rigid surface, for example, of a metal plate. As further contact pressure is applied between the cap and the bottle, the localized contact between the linear edges of the septa and the liner edges of the plate distributes the contact pressure more evenly while minimizing movement of the septum. Accordingly, aspects of the present invention can reduce, in some cases, radically reduce, pressure variations, and reduce deformation of the septum to provide a more uniform and/or more reliable seal.

One embodiment of the present invention is a septum for a circular container cap comprising a sheet of elastomeric material having a thickness and a perimeter comprising at least one linear edge. In one aspect, the at least one linear edge may comprise a plurality of linear edges, for example, a plurality of contiguous linear edges. The plurality of contiguous linear edges form a polygonal perimeter, for example, a hexagonal perimeter.

Another embodiment of the invention is a method for sealing a container comprising or including positioning the septum described above on an open top of a container, for example, a bottle; positioning a plate having at least one liner edge on the septum wherein at least a portion of the at least one linear edge of the plate contacts at least a portion of the one linear edge of the septum; and mounting a container cap on the top of the container having the septum and the plate wherein the container cap compresses the portion of the at least one linear edge of the plate against the portion of the at least one liner edge of the septum to seal the container while minimizing movement of the septum due to engagement of the portion of the linear edge of the plate with the portion of the linear edge of the septum. In one aspect, the at least one linear edge of the septum comprises a plurality of linear edges, for example, forming a hexagonal perimeter. In another aspect, mounting a container cap on the top of the container comprises one of screwing the cap on the container or crimping the cap on the container.

A further embodiment of the invention is a sealing arrangement comprising or including a septum having a perimeter comprising at least one linear edge; a plate having a perimeter comprising at least one linear edge; and a container cap adapted to mount to a container having the septum and the plate wherein the container cap compresses a portion of the at least one linear edge of the plate against a portion of the at least one linear edge of the septum to seal the container while minimizing movement of the septum due to engagement of the portion of the linear edge of the plate with the portion of the linear edge of the seal. The at least one linear edge of the septum may comprise a plurality of linear edges and the at least one linear edge of the plate may comprise a plurality of linear edges.

A still further embodiment of the invention is a sealing arrangement comprising or including a sheet of elastomeric material having a thickness and a perimeter comprising at least one edge portion having a first radial distance; a plate having a thickness and a perimeter comprising at least one edge portion having a second radial distance, less than the first radial distance; and a container cap adapted to mount to a container having the sheet of elastomeric material and the plate wherein the container cap compresses the at least one edge portion of the plate against the at least one edge portion of the sheet of elastomeric material to seal the container while minimizing movement of the a sheet of elastomeric due to engagement of the edge portion of the plate with the edge portion of the elastomeric sheet. The at least one linear edge of the elastomeric sheet may comprises a plurality of linear edges, for example, six contiguous linear edges forming a hexagon.

Details of these aspects of the invention, as well as further aspects of the invention, will become more readily apparent upon review of the following drawings and the accompanying claims.

### BRIEF DESCRIPTION OF THE FIGURES

The subject matter that is regarded as the invention is particularly pointed out and distinctly claimed in the claims at the conclusion of this specification. The foregoing and other objects, features, and advantages of the invention will be readily understood from the following detailed description of aspects of the invention taken in conjunction with the accompanying drawings in which:

FIG. 1 is a perspective view of prior art container top assembly over which the present invention is an improvement.

FIG. 2 is an exploded perspective view of the prior art container top assembly shown in FIG. 1.

FIG. 3 is an exploded perspective view, similar to FIG. 2, of one aspect of the present invention.

FIG. 4 is bottom view of a container top sealing arrangement according to one aspect of the invention.

FIG. 5 is a bottom view of a container top sealing arrangement according to another aspect of the invention.

FIG. 6 is bottom view of a container top sealing arrangement according to yet another aspect of the invention.

FIG. 7 is a schematic plan view of a sheet of septum material during fabrication of the septum shown in FIG. 4.

FIG. 8 is schematic plan view of a sheet of septum material during fabrication of the septum shown in FIG. 5.

FIG. 9 is a schematic plan view of a sheet of septum material during fabrication of the septum shown in FIG. 6.

FIG. 10 is bottom view of a container top sealing arrangement according to another aspect of the invention.

FIG. 11 is a cross section view of the sealing arrangement shown in FIG. 10 as viewed along section lines 11-11 in FIG. 10.

### DETAILED DESCRIPTION OF FIGURES

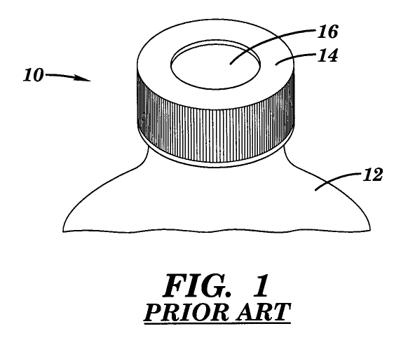

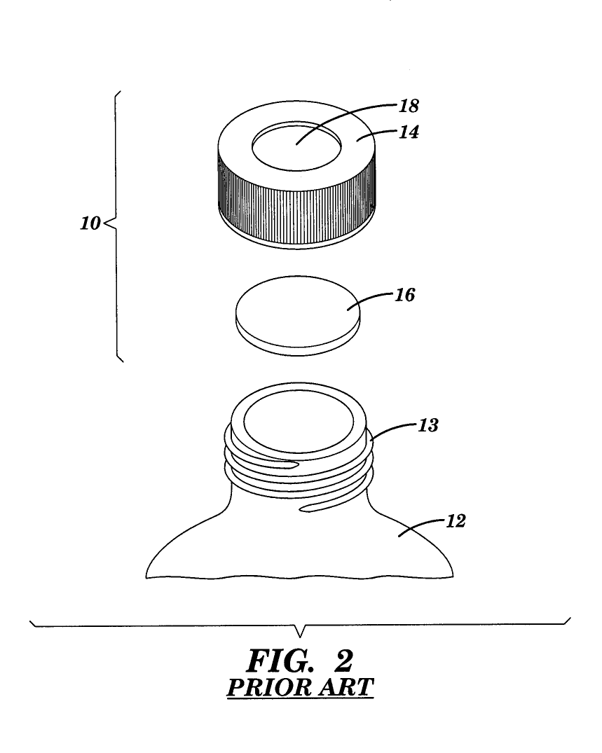

The details and scope of the aspects of the present invention can best be understood upon review of the attached figures and their following descriptions. FIG. 1 is a perspective view of prior art container top assembly 10 mounted to a container, bottle, or vial 12 over which the present invention is an improvement. FIG. 2 is an exploded perspective view of the prior art container top assembly 10 shown in FIG. 1. As shown in FIGS. 1 and 2, as is typical in the art, container top assembly 10 includes a cap 14 mountable to bottle 12, for example, threaded or crimpable to bottle 12, and a septum, liner, or membrane-type seal 16 positioned beneath cap 14. Bottle 12 may include external threads 13. As shown, cap 14 may have a hole 18 in its top where the seal or septum 16 mounted in cap 14 obstructs hole 18. For example, septum 16 may be mounted by means of the methods disclosed in commonly-assigned U.S. Pat. Nos. 5,647,939 and 6,234,335—the disclosures of which are included by reference herein. Septum 16 may typically be an inert elastomeric or rubber material as disclosed in the above referenced patents, for example, a PTFE-laminated silicone rubber, or its equivalent.

As is known in the art, the flexible septum 16 typically provides an effective seal, for example, a fluid-tight seal, between cap 14 and the top of bottle 12 when cap 14 is mounted to bottle 12. Septum 16 also provides a piercible medium through which, for example, a syringe (not shown) may be passed through hole 18 and septum 16 to access the contents of bottle 12 while minimizing or preventing leakage of the contents through the hole created by the syringe.

According to prior art practice, when cap 14 is mounted to bottle 12, for example, by threading or crimping cap 14 over septum 16, septum 16 may be moved or dislodged during the capping process. For example, though accurately positioned prior to capping, when septum 16 is contacted by cap 14 and subsequently cap 14 is rotated or crimped, septum 16 may migrate or move or deform, for example, wrinkle. This movement or deformation may be produced during the rotation of cap 14 when cap 14 is rotated about threads 13 or during the clamping or crushing of the septum 16 when cap 14 is crimped to bottle 12 under pressure. This movement or deformation of septum 16 can interfere with the desired sealing, for example, fluid-tight sealing, of bottle 12. In extreme cases, the movement or deformation of septum 16 during the mounting and tightening of cap 14 to bottle 12 may reduce or even eliminate the desired seal between cap 14 and bottle 12. For example, studies have shown that uneven sealing can occur due to the random pattern of the initial contact of cap 14 with septum 16 and due to the uneven and random movement of septum 16 with respect to bottle 12 and cap 14 as septum 16 adapts to equalize the unequal pressures applied to septum 16 during capping. As discussed below, aspects of the present invention address these and other limitations and disadvantages of the prior art, including the prior art exemplified by container top assembly 10 shown in FIGS. 1 and 2.

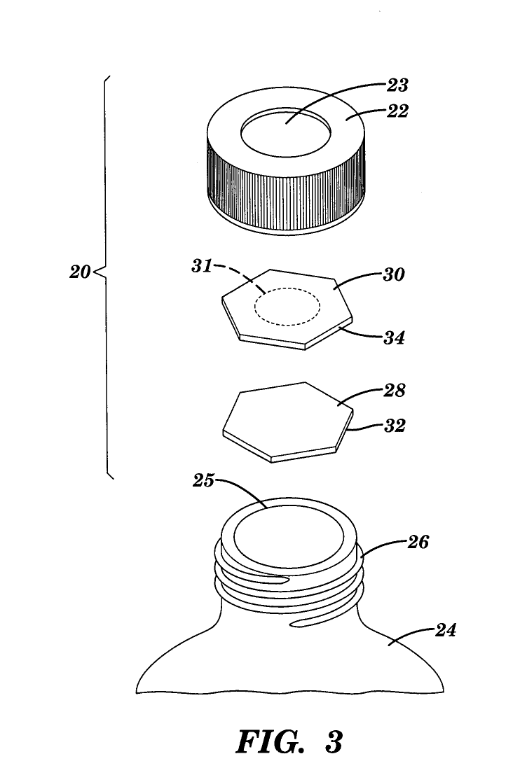

FIG. 3 is an exploded perspective view, similar to FIG. 2, of one container top assembly 20 according to one aspect of the invention. Similar to prior art container top assembly 10 shown in FIGS. 1 and 2, container top assembly 20 includes a cap 22 mountable to a bottle 24, for example, threaded or crimpable to bottle 24. As shown, cap 22 may typically be a circular cap and include a hole or opening 23, for example, a circular hole or opening, in its top. Bottle 24 may include external threads 26, though in one aspect, bottle 24 may have one or more external lips (not shown) adapted to receive a crimpable cap (also not shown). According to the aspect of the invention shown in FIG. 3, container top assembly 20 also includes one or more sealing elements, liners, septa, or seals 28 positioned on the open top 25 of bottle 24, for example, to provide at least some sealing to bottle 24. In another aspect, container top assembly 20 may include one or more sealing elements, liners, septa, or seals 28 and one or more plates 30 that cooperate with septum 28 to provide a more effective seal to bottle 24. That is, in one aspect, one or more septa 28 may be used with or without one or more plates 30 and provide the benefits of aspects of the invention. Septum 28 may typically comprise a sheet of material, for example, an elastomeric material, having a thickness and a perimeter. As is typical of the art, septum 28 may provide a piercible medium through which, for example, a syringe may be passed to access the contents of bottle 24 while minimizing or preventing leakage of the contents through the hole created by the syringe. In order to permit access to septum 28, for example, by a syringe, one or more plates 30 may have an aperture of hole 31, shown in phantom in FIG. 3.

According to one aspect of the invention, septum 28 includes at least one linear edge 32 about a perimeter of septum 28. Also, plate 30 includes at least one linear edge 34 about a perimeter of plate 30. Though in one aspect of the invention septum 28 includes at least one linear edge 32 and plate 30 includes at least one liner edge 34, in other aspects of the invention a plurality of linear edges 32 and a plurality of linear edges 34 may be provided. For example, as shown in FIG. 3, septum 28 and plate 30 may have contiguous linear edges 32, 34, respectively, for instance, six (6) contiguous linear edges 32, 34, to provide a hexagonal-shaped septum 28 and a hexagonal-shaped plate 30.

In this discussion, and throughout this specification and in the appended claims, the meaning of the expression “linear edge” or “linear side” is consistent with the common dictionary meaning. That is, a “linear edge” or a “linear side” is a peripheral edge or side resembling a straight line, for example, a straight line substantially perpendicular to a radius to the edge or side. In one aspect, the linear edge or side is elongated in a direction substantially perpendicular to the axis of the septum or plate, for example, as distinguished from an edge or side substantially elongated parallel to the axis of the septum or plate. The axis of the septum or plate is typically directed substantially perpendicular to the plane of the septum or plate.

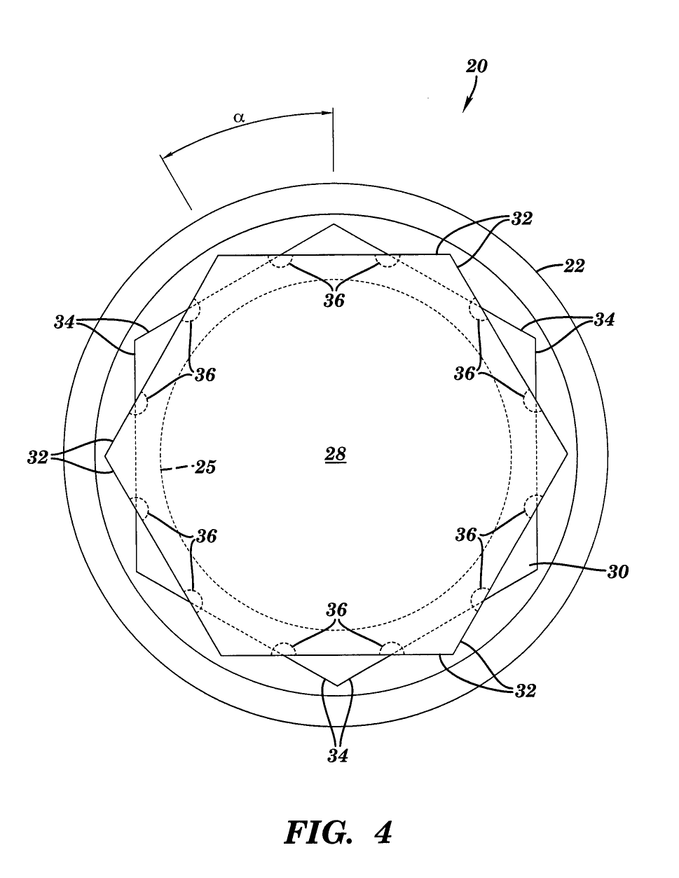

In one aspect, as will be discussed more completely below, when cap 22 is tightened on bottle 24 and over plate 30 and septum 28, the interaction of the at least one linear edge 34 of plate 30 with the at least one linear edge 32 of septum 28, for example, the deformation of septum 28, reduces, minimizes, or even eliminates the relative movement whereby a more effective seal is produced. The interaction of septum 28 and plate 30 according to aspects of the invention can be illustrated more clearly with the aid of FIG. 4.

FIG. 4 is bottom view of a container top sealing arrangement 20 shown in FIG. 3 according to one aspect of the invention. The relative positions and orientations of cap 22, septum 28, and plate 30 according to an aspect of the invention are shown in FIG. 4. In order to facilitate illustration, the projection of open top 25 of bottle 24 is shown in phantom in FIG. 4. As shown, septum 28 is typically as least as large in diameter as the outside diameter of the open top 25 of bottle 24.

As shown in FIG. 4, septum 28 and plate 30 are typically misaligned, rotationally offset, or rotated relative to each other an angle a whereby linear edge 32 of septum 29 overlaps at least partially linear edge 34 of plate 30. Angle a, for example, between the apices of edges 32, 34, respectively, may vary from about 1 degree to about 45 degrees, but is typically between about 5 degrees and about 30 degrees. In one aspect, where septum 28 and plate 30 have equal numbers of edges 32, 34, respectively, septum 28 and plate 30 may be oriented or misaligned where corners or apices between edges 32, 34 are substantially positioned equidistant from the apices of the opposing edges 32, 34. For example, in the aspect of the invention shown in FIG. 4, where septum 28 and plate 30 comprise regular or equilateral hexagons, angel a may be about 30 degrees, that is, one-half the arc subtended by the six equal sides or edges 32, 34 of septum 28 and plate 30, respectively. However, in other aspects, edges 32, 34 need not be symmetrically oriented with respect to each other, and may be offset by any of angle that ensures that at least a portion of edges 32, 34 overlap relative to each other. For example, septum 28 and plate 30 may not be regular or equilateral hexagons, but may be irregular or non-equilateral hexagons and still provide an improved sealing performance.

According to aspects of the invention, due to the overlap of edges 32 and 34, at least one point or region of contact 36, approximated by arcs in FIG. 4, is provided between septum 28 and plate 30 where, the inventors surmise, the loading on septum 28 by plate 30 is concentrated. For example, for the hexagonal septum 28 and the hexagonal plate 30 shown in FIG. 4, twelve (12) regions of contact 36 on septum 28 are provided. In the aspect shown, where hexagonal septum 28 and the hexagonal plate 30 are symmetrically oriented, the twelve regions 36 are also symmetrically positioned about septum 28 and plate 30, though in aspects of the invention, regions 36 may not be symmetrically positioned.

According to aspects of the invention, the interaction of edges 32 and 34, or at least portions of edges 32 and 34, for example, due to the concentration of loading identified by arcs 36, provides at least some resistance to, minimizes, or prevents the movement of septum 28 relative to the open top 25 of bottle 24. This resistance to the movement of septum 28, for example, during the capping process, for instance, during crimping or during screwing on of cap 22, minimizes or prevents the loss of a fluid-tight seal between septum 28 and bottle 24. According to aspects of the invention, “fluid-tight” may comprise liquid-tight, gas-tight, or both. (Further description of the suspected engagement or interaction between septum 28 and plate 30 along edges 32, 34 is illustrated and described with respect to FIG. 11 below.)

Though equal numbers of edges or sides 32 and 34 are shown in FIG. 4, it is envisioned that the number of edges 34 of plate 30 may be greater than or less than the number of edges 32 of septum 28 and still effect the desired improved sealing performance. For example, while septum 28 may have 6 sides, plate 30 may have 4 or 5 sides 34 or 7 or 8 sides 34, or more. In one aspect, plate 30 may be substantially circular and still provide improved sealing. For example, plate 30 may be circular with an outside diameter less than the maximum diameter of the apices of septum 28 whereby edges 32 contact a curvilinear edge of circular plate 30 to provide the desired areas of localized compression 36 on septum 28.

According to aspects of the invention, septum 28 may typically be a pliable or flexible material, for example, pliable in comparison to the material of plate 30. For example, septum 28 may typically be an elastomeric or rubber material, for instance, a natural rubber; a neoprene; a chloroprene; an ethylene-propylene rubber (EDM/EPDM); a urethane, for example, a polyurethane; styrene-butadiene rubber (SBR); isoprene rubber (IR); butadiene rubber (BR); a silicone rubber, for example, a room-temperature vulcanizing (RTV) silicone rubber; and other synthetic rubbers or compounds. In one aspect, septum 28 may be a silicone rubber having a liner (not shown) of a different material that bears against the open top 25 of bottle 23, for example, a liner made of a polytetraflouroethylene (PTFE), such as, DuPont's TEFLON® PTFE or Saint-Gobain's RULON® PTFE, or their equivalents. In one aspect, septum 28 may be made from an inert elastomeric material as disclosed in U.S. Pat. Nos. 5,647,939 and 6,234,335 and may be processed according to the methods described in U.S. Pat. Nos. 5,647,939 and 6,234,335.

Plate 30 may typically be made from a material that is harder than the material of septum 28, but in some aspects, plate 30 may be made from a comparable or softer material than septum 28. Plate 30 may be metallic, plastic, elastomeric, or even made of wood and provide the desired improved sealing performance that characterizes aspects of the invention. For example, plate 30 may be made of iron, steel, stainless steel, spring steel, aluminum, titanium, nickel, magnesium, brass, bronze, or any other structural metal. In one aspect of the invention, plate 30 may be made of a ferromagnetic material, for example, an iron, steel, or iron-containing plastic or rubber whereby when assembled arrangement 20 will be attracted to and coupled by a magnet to facilitate handling and transport. Plate 30 may also be made of one or more of the following plastics: a polyamide (PA), for example, nylon; a polyamide-imide; a polyethylene (PE); a polypropylene (PP); a polyester (PE); a polytetraflouroethylene (PTFE), such as, DuPont's Teflon® PTFE or Saint-Gobain's Rulon® PTFE; an acrylonitrile butadiene styrene (ABS); a polycarbonate (PC); or a vinyl, such as, polyvinylchloride (PVC), among other plastics. Plate 30 may also be made of one or more of the elastomers or rubbers identified above with respect to septum 28 and still effect the improved sealing performance that characterizes aspects of the invention.

Septum 28 and plate 30 may be approximately comparable in thickness and outer diameter, though in some aspects the thicknesses of septum 28 and plate 30 may vary, for example, vary substantially. For example, septum 28 may have a thickness ranging from about 0.01 inches to about 3 inches, for instance, depending upon the size of cap 22. For instance, septum 28 may have a thickness ranging from about 0.01 inches to about 0.50 inches, but is typically between about 0.040 inches and about 0.135 inches. Plate 30 may have a thickness ranging from about 0.01 inches to about 3 inches, for instance, depending upon the size of cap 22. For instance, plate 30 may have a thickness ranging from about 0.01 inches to about 0.50 inches, but is typically between about 0.040 inches and about 0.135 inches. Septum 28 may have an outside dimension or diameter ranging from about 0.125 inches to about 12 inches, for instance, depending upon the size of cap 22. For instance, septum 28 may have an outside dimension ranging from about 0.25 inches to about 6 inches, but is typically between about 0.315 inches (8 millimeters [mm]) and about 4.724 inches (120 mm). Similarly plate 30 may have an outside dimension or diameter ranging from about 0.125 inches to about 12 inches, for instance, depending upon the size of cap 22. For instance, plate 30 may have an outside dimension ranging from about 0.25 inches to about 6 inches, but is typically between about 0.315 inches (8 mm) and about 4.724 inches (120 mm).

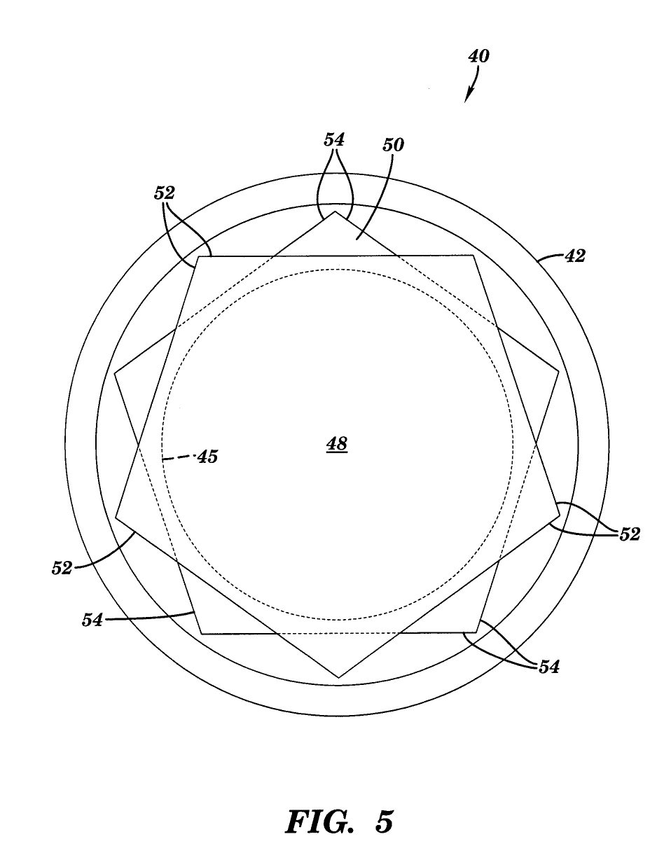

FIG. 5 is a bottom view of a container top sealing arrangement 40 according to another aspect of the invention. Arrangement 40 is similar to arrangement 20 shown in FIG. 4, however, arrangement 40 includes a five-sided (or pentagonal) septum 48 and a five-sided (or pentagonal) plate 50 positioned in a cap 42 which mounts to open top 45 of a container or bottle. In order to facilitate illustration, the projection of open top 45 of a bottle is shown in phantom in FIG. 5. As shown, septum 48 is typically as least as large in diameter as the outside diameter of the open top 45 of the bottle. As shown, according to this aspect of the invention, septum 48 includes five (5) sides 52 and plate 50 includes five (5) sides 54. Except for the number of sides 52, 54, septum 48, plate 50, and arrangement 40 may have all the attributes and functions of septum 28, plate 30, and arrangement 20 shown in FIG. 4. This includes sides 52, 54 may typically interact or engage to minimize or prevent the movement of septum 48, for example, during the capping process to minimize or prevent the loss of a fluid-tight seal between septum 48 and open top 45 of the bottle.

Though equal number of edges or sides 52 and 54 are shown in FIG. 5, it is envisioned that the number of edges 54 of plate 50 may be greater than or less than the number of edges 52 of septum 48 and still effect the desired improved sealing performance. For example, while septum 48 may have 5 sides, plate 50 may have 3 or 4 sides 54 or 6 or 7 sides 54, or more. In one aspect, plate 50 may be substantially circular and still provide improved sealing. For example, plate 50 may be circular with an outside diameter less than the maximum diameter of the apices of septum 48 whereby edges 52 contact a curvilinear edge of circular plate 50 to provide areas of localized compression 36 (see FIG. 4).

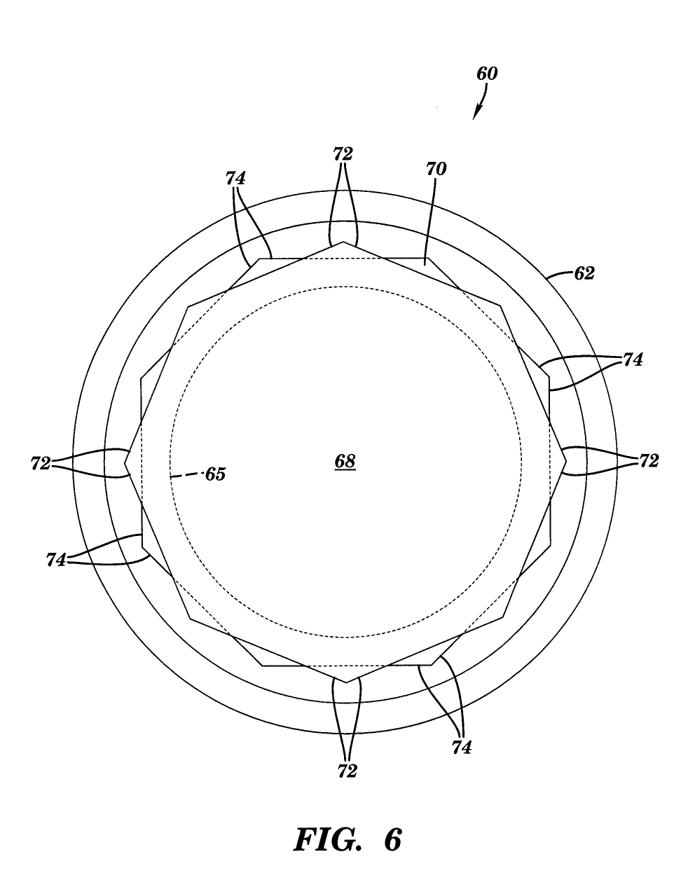

FIG. 6 is a bottom view of a container top sealing arrangement 60 according to another aspect of the invention. Arrangement 60 is similar to arrangements 20 and 40 shown in FIGS. 4 and 5, respectively, however, arrangement 60 includes an eight-sided (or octagonal) septum 68 and a eight-sided (or octagonal) plate 70 positioned in a cap 62 with respect to open top 65 of a container or bottle. In order to facilitate illustration, the projection of open top 65 of the bottle is shown in phantom in FIG. 6. As shown, septum 68 is typically as least as large in diameter as the outside diameter of the open top 65 of the bottle. According to this aspect of the invention, septum 68 includes eight (8) sides 72 and plate 70 includes eight (8) sides 74. Except for the number of sides 72, 74, septum 68, plate 70, and arrangement 60 may have all the attributes and functions of septa 28 and 48, plates 30 and 50, and arrangements 20 and 40 shown in FIGS. 4 and 5, respectively. This includes sides 72, 74 may typically interact or engage to minimize or prevent the movement of septum 68, for example, during the capping process, to minimize or prevent the loss of a fluid-tight seal between septum 68 and open top 65 of the bottle.

Though equal number of edges or sides 72 and 74 are shown in FIG. 6, it is envisioned that the number of edges 74 of plate 70 may be greater than or less than the number of edges 72 of septum 68 and still effect the desired improved sealing performance. For example, while septum 68 may have 8 sides, plate 70 may have 6 or 7 sides 74 or 9 or 10 sides 74, or more. In one aspect, plate 70 may be substantially circular and still provide improved sealing. For example, plate 70 may be circular with an outside diameter less than the maximum diameter of the apices of septum 68 whereby edges 72 contact a curvilinear edge of circular plate 70 to provide the areas of localized compression 36 (see FIG. 4).

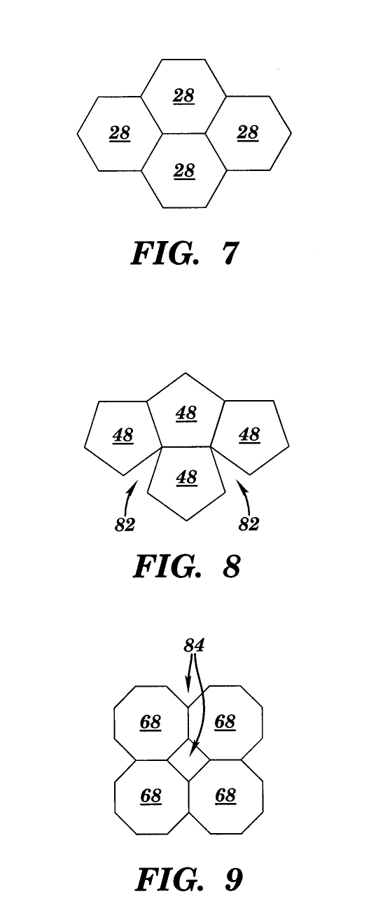

As described above, one or more septa 28, 48, and/or 68 may be used alone or coupled with one or more plates 30, 50, and/or 70 to provide improved sealing performance of caps, for example, crimp-on or screw-on caps. However, as illustrated in FIGS. 7-9, the regular, equilateral, hexagonal, or six-sided, shape provides the advantage of minimizing waste of septum material.

FIG. 7 is a schematic plan view of a sheet of septa material during fabrication of septum 28 shown in FIG. 4. FIG. 8 is a schematic plan view of a sheet of septa material during fabrication of septum 48 shown in FIG. 5. FIG. 9 is a schematic plan view of a sheet of septa material during fabrication of septum 68 shown in FIG. 6. As clearly shown in the comparison of these figures, the compatibility of the shape of adjacent hexagonal septa 28 shown in FIG. 7 clearly shows that when cut from a sheet of septa material, for example, silicone rubber, the shape of septa 28 avoid the waste of other shapes. As shown in FIGS. 8 and 9, the fabrication of pentagonal septa 48 and octagonal septa 68 clearly provide wasted material as indicated by gaps or voids 82 and 84 shown in FIGS. 8 and 9, respectively. That is, according to the invention disclosed in FIG. 5, septa 48 with a regular hexagonal shape can be provided with little or no waste of septa material.

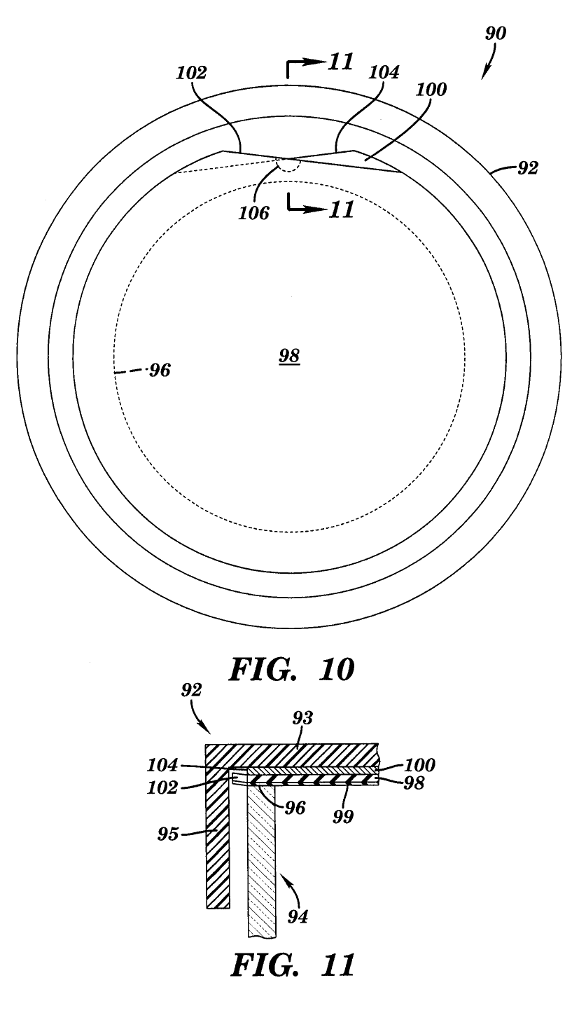

FIG. 10 is bottom view of a container top sealing arrangement 90 according to further aspect of the invention. FIG. 11 is a cross section view of the sealing arrangement 90 shown in FIG. 10 as viewed along section lines 11-11 in FIG. 10. Arrangement 90 is similar to arrangements 20, 40, and 60 shown in FIGS. 4, 5, and 6, respectively, however, arrangement 90 provides a more general depiction of an aspect of the invention. As shown, arrangement 90 includes a septum 98 and a plate 100 positioned in a cap 92 with respect to an open top 96 of a container. Again, in order to facilitate illustration, the projection of open top 96 of a bottle is shown in phantom in FIG. 10. As shown, septum 98 is typically as least as large in diameter as the outside diameter of the open top 96 of the bottle. As also shown, according to this more general aspect of the invention, septum 98 includes at least one side or edge 102 and plate 100 includes at least one side or edge 104 that overlaps and provides at least one location or area 106 where compression loads are concentrated. Again, according to aspects of the invention, this at least one area 106 provides at least some resistance to movement of septum 98 that enhances sealing between septum 98 and open top 96 of the bottle. Except for the number of sides 102 and 104, septum 98, plate 100, and arrangement 90 may have all the attributes and functions of septum 28, plate 30, and arrangement 20 shown in FIG. 4. This includes sides 102, 104 may typically interact or engage to minimize or prevent the movement of septum 98, for example, during the capping process, to minimize or prevent the loss of a fluid-tight seal between septum 98 and open top 96 of the bottle. Though shown with a generally circular shape in FIG. 10, it is envisioned that septum 98 and plate 100 may have any regular or irregular shape while providing at least one edge 102 on septum 98 and at least one edge 104 on plate 100 that overlap to provide a point, area, or portion of contact 106. In addition, edges 102, 104 may be linear as shown, or curvilinear.

The interaction or engagement of septum 98 and plate of 100, and also one envisioned interaction of the engagement of septa and plates disclosed throughout this disclosure is schematically illustrated in FIG. 11. Again, FIG. 11 is a cross section view of the sealing arrangement 90 shown in FIG. 10 as viewed along section lines 11-11 in FIG. 10. As also shown in FIG. 11, septum 98 may include a liner 99, for example, a PTFE liner as discussed previously. The internal threads on cap 92 and the external threads 26 (See FIG. 3) or external crimping lip on bottle 94 are not shown in FIG. 11 to facilitate illustration of this aspect of the invention.

As shown in FIG. 11, cap 92 typically includes a top 93 and a skirt 95, for example, a threaded skirt, for instance, a threaded plastic skirt, or a crimpable skirt, for instance, a crimpable aluminum skirt. With engagement of cap 92 with container 94, for example, a bottle or vial, top 93 of cap 92 contacts and compresses plate 100 against septum 98 whereby septum 98 is compressed against open top 96 of bottle 94. With the compression of plate 100 against septum 98, the at least one edge 104 of plate 100 contacts and impinges upon the at least one edge 102 of septum 98. According to aspects of the invention, the inventor envisions that, due to the flexibility of septum 98, at least a portion of septum 98 located distal or outside edge 104 of plate 100 at least partially extrudes from beneath edge 104, and, possibly, extrudes in the direction of plate 100 (for example, upward as shown in FIG. 11) and provides at least some resistance to the movement of septa 98, for example, at least some resistance to the movement of septum 98 relative to the open top 96 of bottle 94 to minimize the disruption of the desired seal between septum 98 and open top 96. According to aspects of the invention, at least one such interaction between septum 98 and plate 100 may be provided to enhance the sealing performance. It is believed that the plurality of interactions between edges of plates and edges of septa, as described above, only enhances the minimization or prevention of the movement or distortion of septa and enhances the sealing performance of aspects of the invention.

The above discussion presents the varied aspects of the present invention that provide devices and methods for sealing containers, for example, medication or pharmaceutical containers. As will be appreciated by those skilled in the art, features, characteristics, and/or advantages of the various aspects described herein, may be applied and/or extended to any embodiment (for example, applied and/or extended to any portion thereof).

Although several aspects of the present invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A septum for a circular container cap comprising a sheet of elastomeric material having a thickness and a perimeter comprising at least one linear edge.

2. The septum as recited in claim 1, wherein the at least one linear edge comprises a plurality of linear edges.

3. The septum as recited in claim 2, wherein the plurality of linear edges comprises a plurality of contiguous linear edges.

4. The septum as recited in claim 3, wherein the plurality of contiguous linear edges form a polygonal perimeter.

5. The septum as recited in claim 4, wherein the plurality the polygonal perimeter comprises a hexagonal perimeter.

6. The septum as recited in claim 1, wherein the septum further comprises a liner.

7. The septum as recited in claim 6, wherein the liner comprises a polytetraflouroethylene liner.

8. The septum as recited in claim 1, wherein the elastomeric material comprises a silicone rubber.

9. The septum as recited in claim 1, wherein the sheet of elastomeric material has a thickness less than 0.5 inches.

10. The septum as recited in claim 1, wherein the at least one linear edge comprises an edge elongated in a direction substantially perpendicular to an axis of the septum.

11. A method for sealing a container comprising:
positioning the septum as recited in claim 1 on an open top of a container;
positioning a plate having at least one liner edge on the septum wherein at least a portion of the at least one linear edge of the plate contacts at least a portion of the one linear edge of the septum; and
mounting a container cap on the top of the container having the septum and the plate wherein the container cap compresses the portion of the at least one linear edge of the plate against the portion of the at least one liner edge of the septum to seal the container while minimizing movement of the septum due to engagement of the portion of the linear edge of the plate with the portion of the linear edge of the septum.

12. The method as recited in claim 11, wherein the open top of the container comprises a circular open top.

13. The method as recited in claim 11, wherein the at least one linear edge of the septum comprises a plurality of linear edges.

14. The method as recited in claim 13, herein the plurality of linear edges comprises a hexagonal perimeter.

15. The method as recited in claim 11, mounting a container cap on the top of the container comprises one of screwing the cap on the container and crimping the cap on the container.

16. An sealing arrangement comprising:
a septum having a perimeter comprising at least one linear edge;
a plate having a perimeter comprising at least one linear edge; and
a container cap adapted to mount to a container having the septum and the plate wherein the container cap compresses a portion of the at least one linear edge of the plate against a portion of the at least one linear edge of the septum to seal the container while minimizing movement of the septum due to engagement of the portion of the linear edge of the plate with the portion of the linear edge of the seal.

17. The arrangement as recited in claim 16, wherein the at least one linear edge of the septum comprises a plurality of linear edges.

18. The arrangement as recited in claim 16, wherein the at least one linear edge of the plate comprises a plurality of linear edges.

19. The sealing arrangement as recited in claim 16, wherein the septum comprises an elastomeric septum.

20. The sealing arrangement as recited in claim 16, wherein the plate comprises a metallic plate.

21. An sealing arrangement comprising:
a sheet of elastomeric material having a thickness and a perimeter comprising at least one edge portion having a first radial distance;
a plate having a thickness and a perimeter comprising at least one edge portion having a second radial distance, less than the first radial distance; and
a container cap adapted to mount to a container having the sheet of elastomeric material and the plate wherein the container cap compresses the at least one edge portion of the plate against the at least one edge portion of the sheet of elastomeric material to seal the container while minimizing movement of the a sheet of elastomeric due to engagement of the edge portion of the plate with the edge portion of the elastomeric sheet.

22. The arrangement as recited in claim 21, wherein the at least one linear edge of the elastomeric sheet comprises a plurality of linear edges.

23. The arrangement as recited in claim 21, wherein the at least one linear edge of the plate comprises a plurality of linear edges.

24. The sealing arrangement as recited in claim 21, wherein the elastomeric sheet comprises a silicone rubber septum.

25. The sealing arrangement as recited in claim 16, wherein the plate comprises a metallic plate.
